(19) United States
(12) Patent Application Publication
(10) Pub. No.: US 2024/0078366 A1
(43) Pub. Date: Mar. 7, 2024

(54) CIRCUIT DESIGN ADJUSTMENTS USING REDUNDANT NODES

(71) Applicant: Synopsys, Inc., Sunnyvale, CA (US)

(72) Inventors: Eleonora TESTA, Sunnyvale, CA (US); Luca Gaetano AMARU, Santa Clara, CA (US); Patrick Emmanuel VUILLOD, Plateau-des-Petites-Roches (FR)

(21) Appl. No.: 18/139,882

(22) Filed: Apr. 26, 2023

Related U.S. Application Data
(60) Provisional application No. 63/336,595, filed on Apr. 29, 2022.

(51) Int. Cl. G06F 30/323

(52) U.S. Cl. CPC G06F 30/323

(57) ABSTRACT

The present disclosure describes systems and methods for adjusting a logic network. The method includes adding, to the logic network, a first redundant node and determining a first adjustment to a first node of the logic network within a transitive fanin of the first redundant node. The method also includes making the first adjustment to the first node based on determining that a first gain based on the first adjustment satisfies a threshold.

### RELATED APPLICATION

This application claims priority to and the benefit of U.S. Provisional Patent Application Ser. No. 63/336,595, entitled “Extending Rewiring: Reshuffling Don't Cares to Unlock More Optimization,” filed Apr. 29, 2022, which is incorporated herein by reference in its entirety.

### TECHNICAL FIELD

The present disclosure generally relates to an electronic design automation (EDA) system. In particular, the present disclosure relates to circuit design adjustments using redundant nodes.

### BACKGROUND

An EDA system includes logic synthesis where a circuit description described using a hardware description language such as register transfer level (RTL) is transformed into a design implementation of logic gates. Quality of results (QoR) is a performance criteria for the EDA system.

### SUMMARY

The present disclosure describes systems and methods for adjusting a logic network. According to an embodiment, the method includes adding, to the logic network, a first redundant node and determining a first adjustment to a first node of the logic network within a transitive fanin of the first redundant node. The method also includes making the first adjustment to the first node based on determining that a first gain based on the first adjustment satisfies a threshold.

The method may include adding, to the logic network, a second redundant node and determining a second adjustment to a second node of the logic network within a transitive fanin of the second redundant node. The method may include removing the second redundant node from the logic network based on determining that the threshold exceeds a second gain based on the second adjustment.

The first redundant node may be determined based one or more of a truth table or a binary decision diagram of the logic network.

The first adjustment may include removal of the first node.

The first adjustment may include substituting the first node with another node in the logic network.

Adding the first redundant node to the logic network may maintain functionality of an output of the logic network.

The method may include selecting a second node of the logic network and forming, from the second node, a window encompassing the second node and a third node of the logic network. The second node and the third node may be in the transitive fanin of the first redundant node. The first redundant node may be added based on the window. The third node may be outside a transitive fanout of the second node.

The first redundant node may include one or more of an AND gate or an OR gate.

The first gain may include one or more of an area of the logic network, a power consumption of the logic network, or a number of gates in the logic network.

According to another embodiment, a system for adjusting a logic network includes a memory and a processor communicatively coupled to the memory. The processor adds, to the logic network, a first redundant node and determines a first adjustment to a first node of the logic network within a transitive fanin of the first redundant node. The processor also makes the first adjustment to the first node based on determining that a first gain based on the first adjustment satisfies a threshold.

The processor may add, to the logic network, a second redundant node and determine a second adjustment to a second node of the logic network within a transitive fanin of the second redundant node. The processor may remove the second redundant node from the logic network based on determining that the threshold exceeds a second gain based on the second adjustment.

The first redundant node may be determined based on a truth table of the logic network.

The first adjustment may include removal of the first node.

The first adjustment may include substituting the first node with another node in the logic network.

Adding the first redundant node to the logic network may maintain functionality of an output of the logic network.

The processor may select a second node of the logic network and form, from the second node, a window encompassing the second node and a third node of the logic network. The second node and the third node may be in the transitive fanin of the first redundant node. The first redundant node may be added based on the window.

The first redundant node may include one or more of an AND gate or an OR gate.

According to another embodiment, a non-transitory computer readable medium stores instructions that, when executed by a processor, cause the processor to form, from a first node of a logic network, a window encompassing the first node and a second node of the logic network. The second node is in a transitive fanin of the first node. The processor also adds at least one of an AND gate or an OR gate to the logic network such that an output of the first node and an output of the second node are input to the AND gate or gate and based on a truth table of the logic network remaining unchanged after adding the AND gate or gate, determines an adjustment to a third node of the logic network within the transitive fanin of the first node. The processor further makes the adjustment to the third node based on determining that a gain based on the adjustment satisfies a threshold.

The adjustment may include at least one of (i) removing the third node from the logic network or (ii) substituting the third node with another node in the logic network.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example system.

FIGS. 2A, 2B, and 2C illustrate an example of rewiring on a logic network in the system of FIG. 1.

FIGS. 3A, 3B, and 3C illustrate an example rewiring in the system of FIG. 1.

FIGS. 4A, 4B, and 4C illustrates an example resubstitution in the system of FIG. 1.

FIG. 5 is a flowchart of an example method performed in the system of FIG. 1.

FIG. 6 depicts a flowchart of various processes used during the design and manufacture of an integrated circuit in accordance with some embodiments of the present disclosure.

FIG. 7 depicts a diagram of an example computer system in which embodiments of the present disclosure may operate.

### DETAILED DESCRIPTION

Aspects of the present disclosure relate to a system and method for determining adjustments to a circuit design. Specifically, the present disclosure describes a technique for determining adjustments to be made to a logic network of a circuit design to improve the logic network (e.g., reduce the size of the logic network or to improve a given target metric of the logic network). The logic network may be an arrangement of nodes representing logic gates (e.g., AND gates, OR gates, NAND gates, etc.) that perform the logical functions of the circuit design. Each node may represent a logic gate, and a connection between the nodes may represent an electrical connection between the logic gates represented by the nodes.

The functionality of the logic network may be represented or described in different ways (e.g., using different data structures). For example, the functionality of the logic network may be represented or described using a Boolean function, in which the inputs and outputs of the logic network are variables in the Boolean function and the logic gates are operators in the Boolean function. The functionality of the logic network may also be represented or described using a truth table, a binary decision tree, or a satisfiability solver.

The present system and method for adjusting the logic network add, to the logic network, redundant nodes determined based on a representation of the logical functionality of the logic network (e.g., a truth table, binary decision diagram, etc.). A redundant node is a node that, when added to the logic network, does not change the logical functionality of the logic network. For example, adding the redundant node to the logic network may cause the truth table or binary decision tree for the logic network to remain unchanged. Adding the redundant node to the logic network, however, may provide certain adjustments that can be made to the logic network that do not change the logical functionality of the logic network.

For example, the redundant node may be redundant with a combination of multiple nodes in the logic network. Thus, it may be possible to preserve the logical functionality of the logic network by removing the combination of multiple nodes while keeping the redundant node, which may also be referred to as rewiring. Even though the logical functionality of the logic network does not change, removing the combination of multiple nodes and keeping the redundant node may improve the logic network by reducing the number of nodes or logic gates, which may reduce the size and power consumption of the circuit design.

As another example, the redundant node may create a redundancy between or amongst a set of nodes in the logic network. Thus, it may be possible to preserve the logical functionality of the logic network by replacing one or more of those nodes with other nodes in the set, which may also be referred to as resubstitution. Even though the logical functionality of the logic network does not change, replacing the nodes may improve the logic network by reducing the number of nodes or logic gates, which may reduce the size and power consumption of the circuit design.

The adjustment may be made to the logic network if the adjustment provides a desired gain (e.g., sufficiently improves a particular metric related to the operation of the circuit design). For example, the adjustment may be made to the logic network if the adjustment reduces the number of nodes or logic gates in the logic network by an amount exceeding a threshold (e.g., 2 gates). As another example, the adjustment may be made to the logic network if the adjustment reduces the size or area of the circuit design by an amount exceeding a threshold. As another example, the adjustment may be made to the logic network if the adjustment reduces the power consumption of the circuit design by an amount exceeding a threshold. If the adjustment does not sufficiently improve the circuit design, the redundant node may be removed from the logic network, and the system may evaluate another redundant node.

In certain embodiments, the present system and method provide several technical advantages. For example, adding a redundant node to the logic network may allow multiple other nodes to be removed from the logic network or substituted out of the logic network. As a result, the number of nodes or gates in the logic network is reduced, which may reduce the size and power consumption of the circuit design. As another example, the present system and method improve the operation of a computer system by improving the speed at which the logic network adjustment process is performed. The present system and method may reduce the number of nodes in the logic network that are analyzed to determine the redundant node, which reduces the amount of time it takes to determine the redundant node. Additionally, the present system and method may involve analyzing a truth table or binary decision diagram representing the logical functionality of the logic network rather than the structure of the logic network, which also may reduce the amount of time it takes to determine the redundant node. As a result, less computing resources (e.g., processor and memory resources) may be used to perform the technique relative to other techniques for adjusting a logic network. Moreover, the present system and method may perform multiple node optimization that is scalable for large circuit designs, thus improving runtime performance.

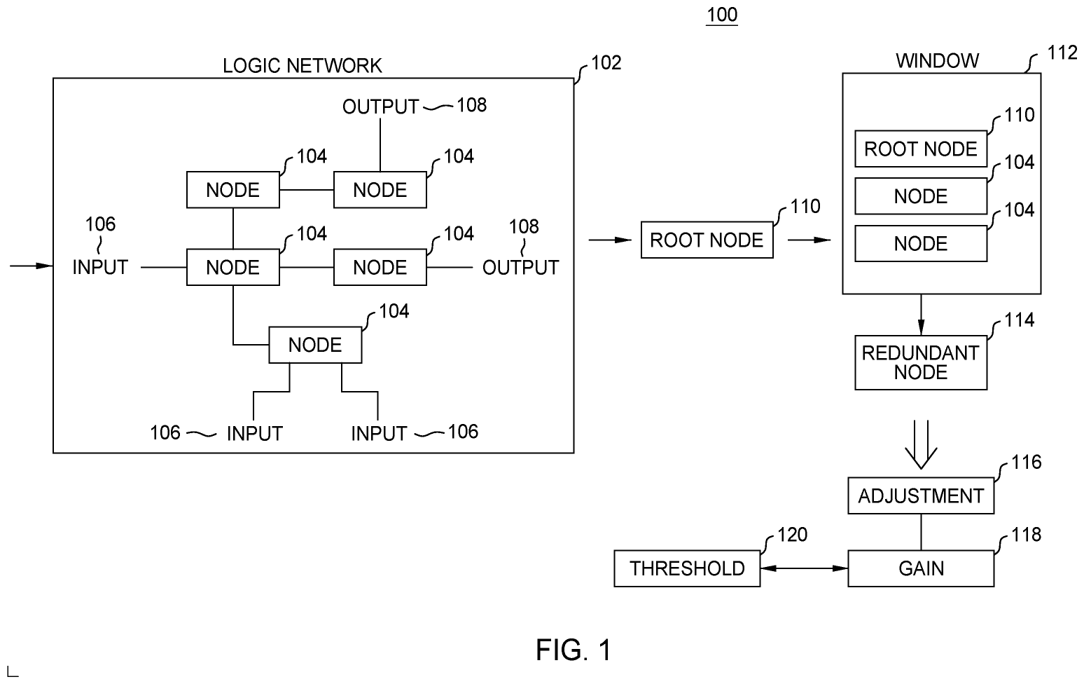

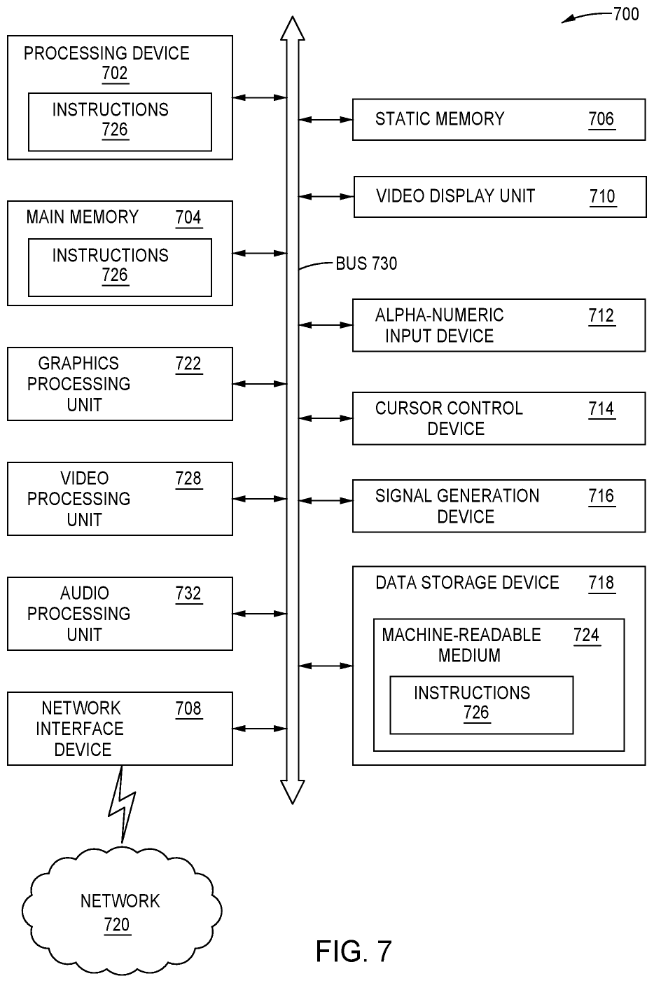

FIG. 1 illustrates an example system 100. The system 100 may be a computer system (e.g., the computer system 700 shown in FIG. 7). Generally, the system 100 adds one or more redundant nodes to a logic network and analyzes the redundant nodes to determine if improvements can be made to the logic network. If the adjustments provide a desired gain (e.g., reduce the number of gates by an amount exceeding a threshold, reduce the area or size of the circuit design by an amount exceeding a threshold, reduce the power consumption of the circuit design by an amount exceeding a threshold, etc.), then the system 100 may make the adjustment to the logic network.

The system 100 receives a logic network 102. The logic network 102 may be a logical representation of a circuit design. As seen in FIG. 1, the logic network 102 includes a number of nodes 104. Each node 104 may represent a logic gate (e.g., AND gate, OR gate, NAND gate, etc.). The connections between the nodes 104 indicate an electrical connection between the logic gates represented by those nodes 104. Some of the nodes 104 may receive inputs 106, which may be electrical signals into the circuit design. Some of the nodes 104 produce outputs 108, which may be electrical signals produced by the circuit design. As a result, arrangement and connections of the nodes 104, the inputs 106, and the outputs 108 represent the logical functionality of the circuit design.

The system 100 performs a technique to determine adjustments that can be made to the logic network 102 without changing the logical functionality of the logic network 102. The system 100 begins by selecting a node 104 from the logic network 102 to serve as a root node 110. The root node 110 may be any node 104 in the logic network 102. The system 100 may select a different node 104 to serve as the root node 110 during each iteration of the technique.

After the system 100 selects the root node 110, the system 100 forms a window 112 that encompasses the root node 110 and other nodes 104 in the logic network 102. Generally, the system 100 forms the window 112 by adding nodes 104 that are in the transitive fanin of the root node 110 (e.g., nodes 104 that are positioned between an input 106 and an input to the root node 110 in the logic network 102). For example, the system 100 my start at the root node 110 and add nodes 104 that provide an input to the root node 110. The system 100 may then add other nodes 104 that provide inputs to the previously added nodes 104. This process may continue until the number of nodes 104 in the window 112 reaches a threshold number of nodes or until there are no more nodes 104 to add to the window 112. Additionally, nodes 104 in the logic network 102 that are in the transitive fanout of the root node 110 (e.g., nodes 104 that are positioned between an output 108 and an output of the root node 110 in the logic network 102) are excluded from the window 112. For example, nodes 104 that receive outputs from the root node 110 are excluded from the window 112.

In some embodiments, the system 100 filters the window 112 to determine whether subsequent analysis should be performed or adjusted. For example, if the window 112 includes too few nodes 104 (e.g., less than a threshold number of nodes), then the system 100 may restart the process and select another root node 110. As another example, if a node 104 in the window 112 has a fanin cone with too few nodes 104 (e.g., a small maximum fanout free cone (MFFC), where a MFFC of a node n is a set of nodes that includes (i) the node n and (ii) the nodes in the transitive fanin of n whose fanout is contained in the set of nodes) or if a node 104 in the window 112 has a large number of outputs (e.g., fanouts), then the system 100 may remove these nodes 104 from the window 112 before proceeding.

The system 100 may then determine a redundant node 114 to be added to the logic network 102. Generally, the redundant node 114 is added to the logic network 102 so that the root node 110 is in the fanin of the redundant node 114. Additionally, when added to the logic network 102, the redundant node 114 does not change the logical functionality of the logic network 102 (e.g., the logic network 102 produces the same outputs 108 for the same inputs 106). The system 100 may determine the redundant node 114 by determining candidates. For example, for each node 104 in the window 112, the system 100 may add an AND gate or an OR gate between the root node 110 and the respective node 104. This AND gate or gate may receive the outputs of the root node 110 and the respective node 104 as inputs. The output of the AND gate or the OR gate may be set as the output of the root node 110. The system 100 may then determine whether connecting the AND gate or the OR gate in this manner changes the logical functionality of the logic network 102 (e.g., determine if the truth table, binary decision tree, or Boolean function for the logic network 102 changes or determine if the logic network 102 produces different outputs 108 for the same inputs 106). If the logical functionality of the logic network 102 does not change, then the AND gate or the OR gate is added as a candidate for being the redundant node. The system 100 may then determine whether the other type of gate (e.g., an OR gate or an AND gate) connected in the same manner is a candidate. The system 100 may repeat this process for other pairs of root node 110 and a respective node 104 in the window 112 to identify candidates.

In some embodiments, for each pair of root node 110 and node 104 in the window 112, the system 100 also connects the AND gate or gate to the complements of the root node 110 and the node 104 to determine whether those additions can serve as potential redundant nodes 114. For example, the system 100 may connect, as inputs to an AND gate or an OR gate, the complements of one or both outputs of the root node 110 and the node 104. The system 100 may analyze each of these additions to determine whether they change the logical functionality of the logic network 102.

After determining the candidates, the system 100 may sort the candidates and select a redundant node 114 from the candidates. The system 100 may sort the candidates using any suitable cost metric. Various heuristics could be considered to sort the candidates. For instance, the size of the MFFC or the number of fanout of the nodes 104. Another considered heuristic may consider if the node 104 is in the fanin of the root node 110. The system 100 may then select the redundant node 114 from the sorted candidates.

After selecting the redundant node 114, the system 100 adds the redundant node 114 to the logic network 102. For example, the redundant node 114 may be connected to the root node 110 and the node 104 in the window 112 (e.g., with contemplated complementing). The system 100 may then analyze the logic network 102 to determine whether the redundant node 114 creates other redundancies in the logic network 102. For example, the system 100 may determine whether other nodes 104 in the logic network 102 are redundant of the redundant node 114 or whether the redundant node 114 renders a node 104 in the logic network 102 redundant with one or more other nodes 104 in the logic network 102.

The system 100 may then determine an adjustment 116 based on these determined redundancies. For example, if other nodes 104 in the logic network 102 are redundant of the redundant node 114, the system 100 may determine the adjustment 116 to be removal of the other nodes 104, which may be referred to as rewiring. As another example, if the redundant node 114 renders a node 104 in the logic network 102 redundant with one or more other nodes 104 in the logic network 102, the system 100 may determine the adjustment 116 to be replacement of the one or more nodes 104 with the node 104, which may be referred to as resubstitution.

The system 100 may determine a gain 118 produced by making the adjustment 116. The gain 118 may be determined according to any suitable metric. For example, the gain 118 may indicate a reduction in the number of gates in the logic network 102. As another example, the gain 118 may indicate a reduction in the size or area of the circuit design. As another example, the gain 118 may indicate a reduction in the power consumption of the circuit design. The system 100 may compare the gain 118 with a threshold 120 to determine if the gain 118 exceeds the threshold 120. If the gain 118 exceeds the threshold 120, the system 100 may make the adjustment 116 to the logic network 102. If the gain 118 does not exceed the threshold 120, the system 100 may remove the redundant node 114 from the logic network 102. In this manner, the system 100 improves the logic network 102 (e.g., reduces the number of gates in the logic network 102, reduces the size or area of the circuit design, reduces the power consumption of the circuit design, etc.).

An example flow for the technique is depicted below in Algorithm 1. The technique may be made scalable by being applied to small windows 112 of nodes 104 (e.g., approximately 15 inputs) or medium-sized windows 112 of nodes 104 (e.g., approximately 20 inputs). Each node 104 is considered (e.g., in topological order) as the root node 110 (Lines 1 and 2). The window 112 for a root node 110 may be obtained by adding nodes 104 in the fanin of the root node 110. The procedure stops when a threshold size limit is reached or there are no nodes 104 to be added.

After sorting the window 112 (e.g., in topological order), the algorithm proceeds with the computation of the redundant nodes. This part of the algorithm (Lines 15 and 16) is the one used to find candidate redundant nodes that could be added to the logic network 102. After the candidates' computation, the algorithm continues by adding the candidates and trying adjustments for each of the candidates. A limit on the maximum number of candidates to be tried can be set to improve the runtime. In some embodiments, only nodes 104 in the fanin (e.g., transitive fanin) of the newly added redundant node 114 are tried for possible adjustments 116 (lines 24-25 of the algorithm). Lines 23-27 of the algorithm are used in case advantageous adjustments for a node n are found. This includes: update of the truth tables, computation of the gain 118 of the adjustment 116, storing the adjustment 116 to be committed. The flow continues then to the next node 104.

After trying all nodes 104 in the fanin of the redundant node 114, two scenarios may occur:
The gain 118 does not satisfy the threshold 120. In this case, the redundant node 114 is removed, and the computation attempts using another of the possible redundant candidates (if available).
The gain 118 is larger than the threshold 120, the adjustment 116 is committed to the logic network 102. The algorithm may continue with the next root node 110 in the logic network 102.

Algorithm 1 Rewiring with truth-tables and flexibilities

Input: Logic network, cut-size, filter-volume, max-candidates (mc),
max_level, max_fanout, cost, min_gain, min_mffc
Output: Resynthesized logic network

| | |
|---|---|
| 1: | list ← topological-sort-network(network) |
| 2: | for each node root in list do |
| 3: | if node_mffc(root) < min_mffc then |
| 4: | continue |
| 5: | end if |
| 6: | if fanout_node(root) > max_fanout then |
| 7: | continue |
| 8: | end if |
| 9: | cut ← find-reconvergent-cut(root, cut-size) |
| 10: | window ← expand-cut-into-window(root, cut) |
| 11: | if volume window / size window < filter-volume then |
| 12: | continue |
| 13: | end if |
| 14: | compute-truth-tables(window) |
| 15: | wdw ← topological-sort-network(window) |
| 16: | redund_nodes ← compute-and-sort-candidates(wdw, root, |
| | max_level, max_fanout, cost) |
| 17: | for node r in redund_nodes do |
| 18: | if try_nodes > mc then |
| 19: | break |
| 20: | end if |
| 21: | try_nodes++ |
| 22: | add-wire-to-cut(wdw,W) |
| 23: | updated-truth-tables(wdw) |
| 24: | tfi ← transitive-fanin(r,wdw) |
| 25: | for node n in tfi do |
| 26: | flexibility ← compute-flexibility(n, wdw) |
| 27: | if no_flexibilities(n, wdw) then |
| 28: | continue |
| 29: | end if |
| 30: | update-information-with-flexibility(n, flexibility) |
| 31: | optimizations = find-optimizations(n) |
| 32: | if optimizations != 0 then |
| 33: | update-truth-table-tfo(n) |
| 34: | gain ← gain-optimizations(optimizations) |
| 35: | commit ← optimizations-to-commit(optimizations) |
| 36: | continue /* goes to next node in TFI of r */ |
| 37: | end if |
| 38: | end for |
| 39: | if gain > min_gain then |
| 40: | commit-optimizations-update-network(network, commit) |
| 41: | else |
| 42: | remove-node-from-window(wdw, r) |
| 43: | end if |
| 44: | end for |
| 45: | end for |
| 46: | network-cleanup-and-sweeping(network) |

An example flow for determining candidates for redundant nodes is shown below in Algorithm 2, which is also referred to as a procedure called compute-and-sort-candidates in Line 16 of Algorithm 1. This procedure is used to find potential redundant nodes 114 to be added to the logic network 102. The AND gate or gate between the root node 110 and another node 104 in the window 112 are considered for determining redundant nodes 114. The new node is redundant if it does not change the truth table of the root node 110 or the logic network 102. The nodes 104 immediately connected to the inputs of the root node 110 may not be considered as potential candidates (see Line 11 of Algorithm 2). If a node 104 is redundant, it is added in the array of potential redundant nodes to be added to the logic network 102. Both the AND/OR of the two nodes and their complemented versions are considered. In this implementation, the redundant check is performed using truth tables. Thus, a node 104 is considered redundant if the truth table of the AND/OR(root, n) is the same as the root node 110.

Algorithm 2 Compute candidates - redundant nodes

Input: Root node root, window wdw, max_fanout, max_level, cost
Output: Array of redundant nodes

| | |
|---|---|
| 1: | for each node n in wdw do |
| 2: | if n is constant then |
| 3: | continue |
| 4: | end if |
| 5: | If fanout_node(n) > max_fanout then |
| 6: | continue |
| 7: | end if |
| 8: | if level_node(n) > level_node(root) + max_level then |
| 9: | continue |
| 10: | end if |
| 11: | if is_fanin(root,n) then |
| 12: | continue |
| 13: | end if |
| 14: | if is_AND_OR_redundant(root,n) then |
| 15: | array_insert(redund_nodes, n) |
| 16: | end if |
| 17: | end for |
| 18: | sort_candidates_with_cost(redund_nodes, cost) |

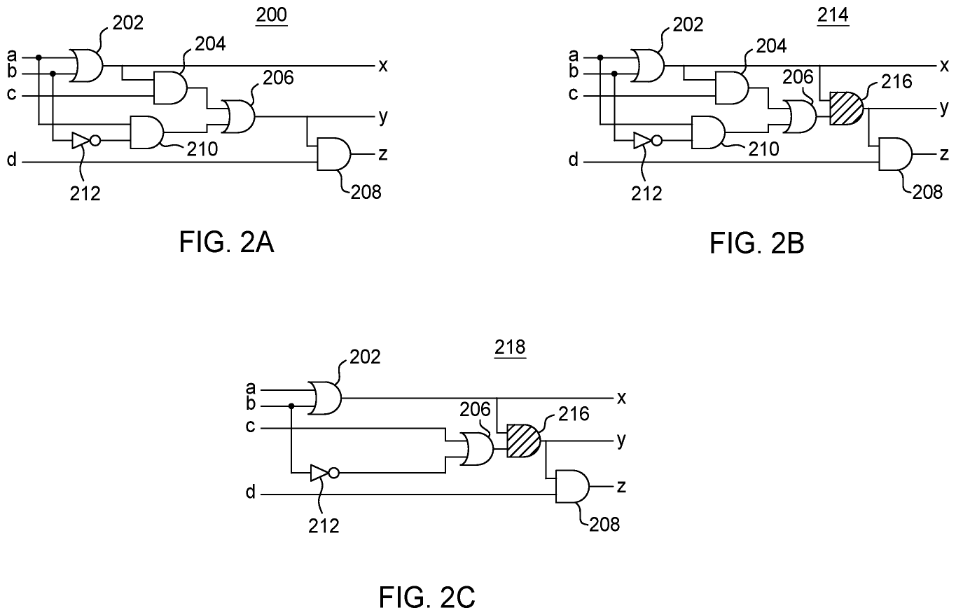

FIGS. 2A, 2B, and 2C illustrate an example logic network adjustment in the system of FIG. 1. FIG. 2A illustrates an example logic circuit 200. The circuit 200 includes an OR gate 202, an AND gate 204, an OR gate 206, an AND gate 208, an AND gate 210, and an inverter 212. The OR gate 202 receives the inputs a and b and produces the output x. The AND gate 204 receives the input c and the output of the OR gate 202. The inverter 212 inverts the input b. The AND gate 210 receives the input a and the output of the inverter 212. The OR gate 206 receives the outputs of the AND gate 204 and the AND gate 210 and produces the output y. The AND gate 208 receives the input d and the output of the OR gate 206 and produces the output z. The system 100 may analyze the logic circuit 200 to determine a redundant node to add to the circuit 200.

FIG. 2B illustrates an example logic circuit 214. As seen in FIG. 2B, the AND gate 216 has been added to the logic circuit 200 to form the logic circuit 214. The AND gate 216 receives the outputs of the OR gate 202 and the OR gate 206 and produces the output y. The AND gate 208 receives the input d and the output of the AND gate 216 and produces the output z. The truth table (e.g., a table that shows the values of the outputs x, y, and z for every value of the inputs a, b, c, and d) for the logic circuit 200 is the same as the truth table for the logic circuit 214, which indicates that the AND gate 216 is a redundant node.

The system 100 may analyze the logic circuit 214 to determine whether the AND gate 216 renders any of the other logic gates redundant. In this example, the system 100 may determine that the AND gate 216 renders redundant the AND gate 204 and the AND gate 210. The system 100 may analyze any suitable data structure (e.g., truth table or binary decision diagram) to determine whether certain logic gates are rendered redundant. For example, the system 100 may analyze the truth table for the logic circuit 214 to determine that removing the AND gate 204 and the AND gate 210 from the logic circuit 214 does not change the truth table for the entire logic circuit 214. The system 100 may determine that after adding the AND gate 216 to the logic circuit 214, additional logic optimizations—not possible without the redundant node—may instead be revealed. This is because the new added node may modify the don't care conditions of some of the other nodes (i.e., some adjustments to these nodes do not affect the output functionality of the logic circuit 214). For example, the truth tables may reveal that—because changing these don't-care conditions, the AND gates 204 and 210 may be removed from the logic circuit 214 without changing the output of the logic circuit 214. As a result, the system 100 may remove the AND gate 204 and the AND gate 210 from the logic circuit 214, which may be referred to as rewiring.

FIG. 2C illustrates a logic circuit 218 formed by removing the AND gate 204 and the AND gate 210 from the logic circuit 214. As seen in FIG. 2C, the OR gate 206 is now connected to the input c and the output of the inverter 212. Additionally, the logic circuit 218 has one fewer logic gate than the logic circuit 200. As a result, the logic circuit 218 may have a smaller size or area than the logic circuit 200, and the logic circuit 218 may consume less power than the logic circuit 200.

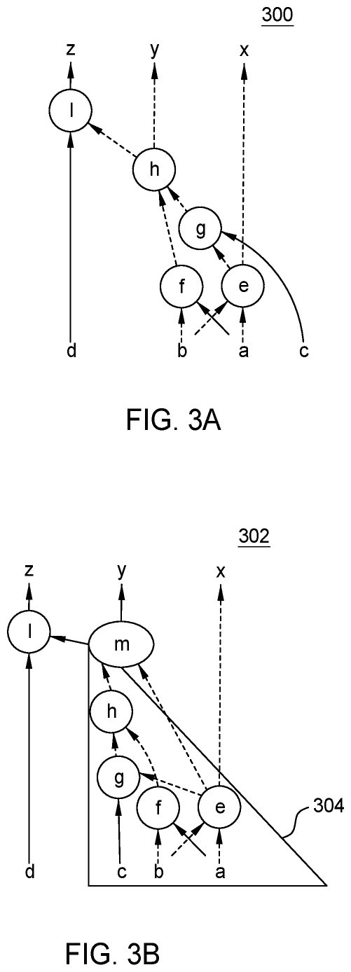

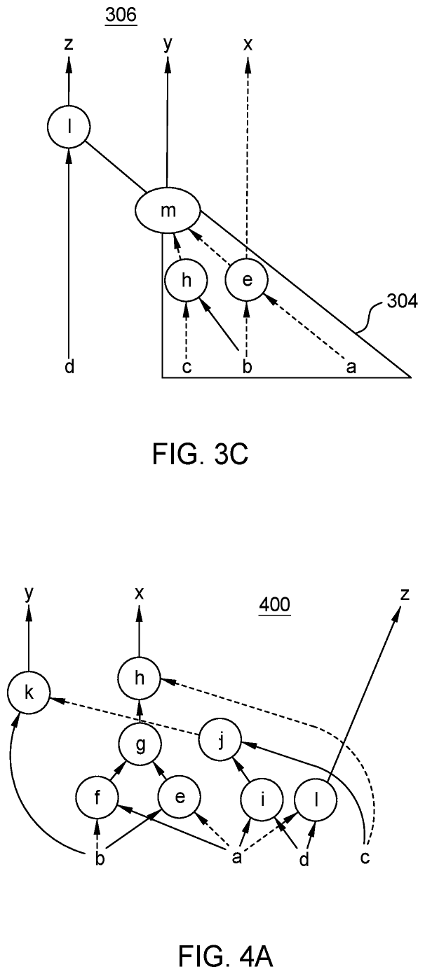

FIGS. 3A, 3B, and 3C illustrate an example rewiring in the system of FIG. 1. FIG. 3A illustrates an example logic network 300. As seen in FIG. 3A, the logic network 300 includes nodes labeled e, f, g, h, and l. Each of these nodes may represent an AND gate. The logic network 300 also includes arrows connecting the nodes to inputs, outputs, and each other. A dashed arrow indicates a complemented or inverted connection. A solid arrow indicates an uncomplemented or non-inverted connection. The example logic network 300 may be equivalent to the logic circuit 200 shown in FIG. 2A. Specifically, the OR gates in the logic circuit 200 have been replaced with inversions and the AND gates represented by the nodes e, f, g, h, and l.

The node e receives as inputs the complement of a and the complement of b. The complement of the output of the node e is the output x of the logic network 300. The node f receives as inputs a and the complement of b. The node g receives c and the complement of the output of the node e as inputs. The node h receives the complement of the output of the node f and the complement of the output of the node g as inputs. The complement of the output of the node h is the output y of the logic network 300. The node l receives d and complement of the output of the node h as inputs. The output of the node l is the output z of the logic network 300.

FIG. 3B illustrates an example logic network 302. The logic network 302 is the logic network 300 with the addition of a redundant node m. The node m may represent an AND gate and may be analogous to the AND gate 216 shown in FIG. 2B. Specifically, the node h was selected as the root node, and the node m connected to the outputs of the nodes e and h was determined to be a candidate. Stated differently, adding the node m to the logic network 300 such that the node m receives the complement of the output of the node e and the complement of the output of the node h as inputs and such that the output of the node m is directed as the output y of the logic network 302 and directed towards the node l does not change the logical functionality of the logic network 300 (e.g., the truth table, binary decision diagram, or Boolean function for the logic network 302 is the same as the truth table, binary decision diagram, or Boolean function of the logic network 300). Thus, the node m is a redundant node.

Specifically, adding the node m to the logic network 300 may add new don't care conditions for nodes of the logic network 300. Some of the other nodes of the logic network 302 may include new don't care conditions (e.g., some nodes may be changed without affecting the output of the logic network 302). Under these don't care conditions, some of the nodes may have any logical value without changing the output of the logic network 302. By adding the redundant node m and by changing or shuffling the values of these don't care conditions, the truth table may reveal additional optimizations that may be made. For example, the truth table may reveal that certain nodes in the logic network 302 may be removed without affecting the operation of the logic network 302.

The triangle 304 indicates the fanin (e.g., transitive fanin) of the redundant node m. As seen in FIG. 3B, the fanin of the node m includes the nodes e, f, g, and h (and the inputs a, b, and c). Thus, the nodes e, f, g, and h are evaluated to determine whether the node m creates redundancies with one or more of the nodes e, f, g, and h. In the examples of FIGS. 3A, 3B, and 3C, the node m creates redundancies with the nodes f and g. Thus, the nodes f and g may be removed without changing the logical functionality of the logic network 302.

FIG. 3C illustrates an example logic network 306. As seen in FIG. 3C, the nodes f and g have been removed as a result of their redundancy with the node m, which may be referred to as rewiring. In the logic network 306, the node e receives the complement of a and the complement of b as inputs. The complement of the output of the node e is the output x of the logic network 306. The node h receives b and the complement of c as inputs. The node m receives the complement of the output of the node e and the complement of the output of the node h as inputs. The output of the node m is the output y of the logic network 306. The triangle 304 indicates that the fanin of the node m now includes the nodes e and h (and the inputs a, b, and c). The node l receives d and the output of the node m as inputs. The output of the node l is the output z of the logic network 306.

By adding the redundant node m and removing nodes that are redundant with the node m (e.g., the nodes f and g), the number of nodes (and thus, the number of logic gates) is reduced by one. Specifically, the logic network 306 has one fewer node than the logic network 300. Thus, the rewiring technique may have reduced the size/area or power consumption of the circuit design corresponding to the logic network 300.

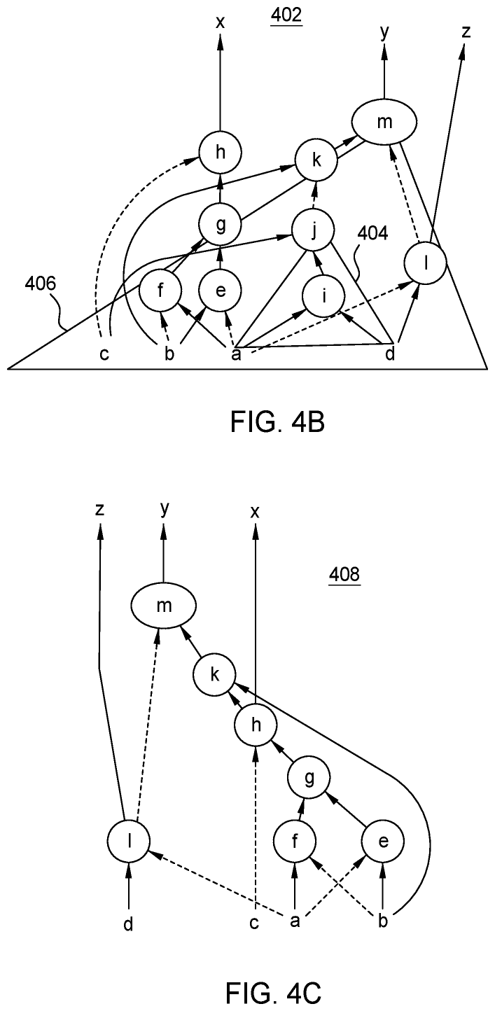

FIGS. 4A, 4B, and 4C illustrates an example resubstitution in the system of FIG. 1. FIG. 4A illustrates an example logic network 400. As seen in FIG. 4A, the logic network 400 includes the nodes e, f, g, h, i, j, k, and l. Each of these nodes may represent an AND gate. The logic network 400 also includes arrows connecting the nodes to inputs, outputs, and each other. A dashed arrow indicates a complemented or inverted connection. A solid arrow indicates an uncomplemented or non-inverted connection.

The node e receives as inputs b and the complement of a. The node f receives as inputs a and the complement of b. The node g receives as inputs the outputs of the nodes e and f. The node h receives as inputs the complement of c and the output of the node g. The output of the node h is the output x of the logic network 400. The node i receives as inputs a and d. The node j receives as inputs c and the output of the node i. The node k receives as inputs b and the complement of the output of the node j. The output of the node k is the output y of the logic network 400. The node l receives as inputs d and the complement of a. The output of the node l is the output z of the logic network 400.

FIG. 4B illustrates an example logic network 402. The logic network 402 is the logic network 400 with the addition of a redundant node m. Specifically, the node k was selected as the root node, and the node m (representing an AND gate) connected to the outputs of the nodes k and l was determined to be a candidate. Stated differently, adding the node m to the logic network 400 such that the node m receives the output of the node k and the complement of the output of the node l as inputs and such that the output of the node m is directed as the output y of the logic network 402 does not change the logical functionality of the logic network 400 (e.g., the truth table, binary decision diagram, or Boolean function for the logic network 402 is the same as the truth table, binary decision diagram, or Boolean function of the logic network 400). Thus, the node m is a redundant node.

The triangle 406 indicates the fanin (e.g., transitive fanin) of the redundant node m. The triangle 404 indicates the fanin (e.g., transitive fanin) of the node j. As seen in FIG. 4B, the fanin of the node m includes the nodes e, g, i, j, k, and l (and the inputs a, b, c, and d). Thus, the nodes e, g, i, j, k, and l are evaluated to determine whether the node m creates redundancies between any of the nodes e, g, i, j, k, or l and another node in the logic network 402. In the examples of FIGS. 4A, 4B, and 4C, the node m creates redundancies between the node j and the node h. Thus, resubstitution may affect the node j and the node i, which is in the triangle 404. During resubstitution, the node j may be replaced with the node h without changing the logical functionality of the logic network 402.

FIG. 4C illustrates an example logic network 408. As seen in FIG. 4C, the node j has been substituted or replaced by the node h. Specifically, the node e receives b and the complement of a as inputs. The node f receives a and the complement of b as inputs. The node g receives the outputs of the nodes e and f as inputs. The node h receives the complement of c and the output of g as inputs. The output of the node h is the output x of the logic network 408. Because the node j has been replaced by the node h, the node k receives b and the output of the node h as inputs. The node l receives d and the complement of a as inputs. The output of the node l is the output z of the logic network 408. The node m receives the output of the node k and the complement of the output of the node l as inputs. The output of the node m is the output y of the logic network 408.

By adding the redundant node m and substituting the node j with the node h, the number of nodes (and thus, the number of logic gates) is reduced by one. Specifically, the logic network 408 has one fewer node than the logic network 400. Thus, the resubstitution technique may have reduced the size/area or power consumption of the circuit design corresponding to the logic network 400.

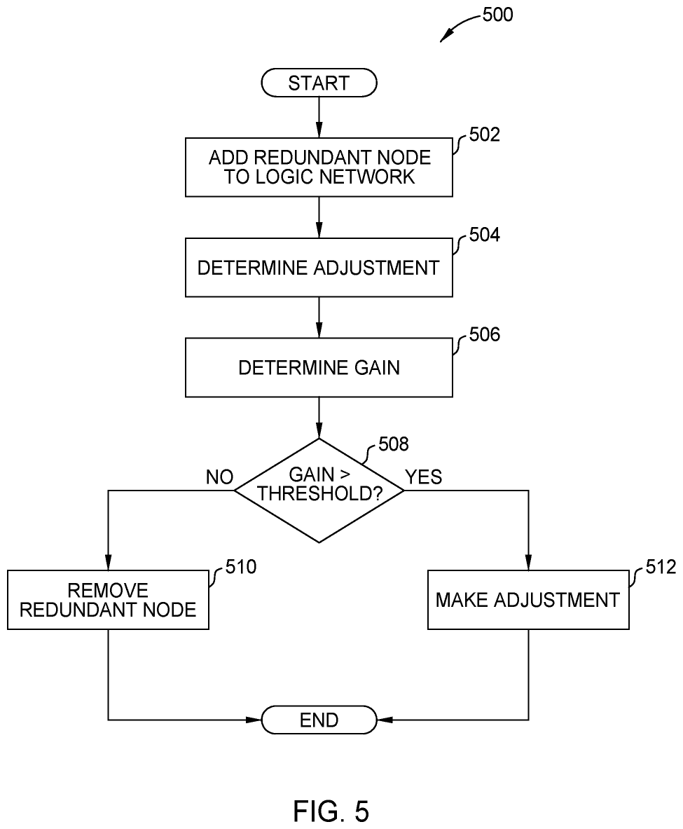

FIG. 5 is a flowchart of an example method 500 performed in the system of FIG. 1. In particular embodiments, a computer system (e.g., the system 100 and the computer system 700 shown in FIG. 7) perform the method 500. By performing the method 500, the computer system determines an adjustment to a logic network 102 that may improve the logic network 102 (e.g., reduce the size/area of the logic network 102, reduce the gate count in the logic network 102, or reduce power consumption of the logic network 102).

At 502, the computer system adds a redundant node 114 to the logic network 102. The logic network 102 may include multiple nodes 104 representing logic gates (e.g., AND gates, OR gates, NAND gates, etc.). The nodes 104 may be connected to indicate an electrical connection between the logic gates represented by those nodes 104. The nodes 104 may also be connected to inputs 106 and outputs 108 of the logic network 102.

The computer system may perform multiple iterations of a windowing process to determine candidates for the redundant node 114. In each iteration, the computer system may select a node 104 of the logic network 102 to serve as a root node 110. The computer system may then form a window 112 that includes the root node 110 and nodes 104 in the fanin of the root node 110. The computer system may then determine whether adding an AND gate or an OR gate between the root node 110 (and its complement) and each other node 104 (and their complements) in the window 112 will change the logical functionality of the logic network 102. The AND gates and OR gates that do not change the logical functionality of the logic network are added as candidates. The computer system may perform multiple iterations of this process, selecting a different node 104 to serve as the root node 110 in each iteration. After the candidates are determined, the computer system selects one of the candidates as the redundant node 114. This selection may be made according to any desired metric.

At 504, the computer system determines an adjustment 116. The computer system may add the redundant node 114 to the logic network 102. The computer system may then determine whether the redundant node 114 creates redundancies with other nodes 104 in the logic network 102 or creates redundancies between or amongst nodes 104 in the logic network 102. The computer system may then determine the adjustment 116 using these determined redundancies. For example, if the redundant node 114 creates a redundancy with other nodes 104 in the logic network 102, the computer system may remove these other nodes 104 (which may also be referred to as rewiring). As another example, if the redundant node 114 creates redundancies between a node 104 and another node 104, then the node 104 may be replaced with the other node 104 (which may also be referred to as resubstitution).

At 506, the computer system determines a gain 118 of the adjustment 116. The gain 118 may be determined according to any suitable metric. For example, the gain 118 may indicate a number of logic gates removed from the logic network 102 due to the adjustment 116. As another example, the gain 118 may indicate a reduction in the size or area of the logic network 102 due to the adjustment 116. As another example, the gain 118 may indicate a reduction in the power consumption of the logic network 102 due to the adjustment 116.

At 508, the computer system compare the gain 118 to a threshold 120 to determine whether the adjustment 116 should be made. If the gain 118 does not exceed the threshold 120, the computer system may not make the adjustment 116. The computer system may remove the redundant node 114 from the logic network 102 in block 510. The computer system may then end the method 500 or select another candidate to be the redundant node 114. If the gain 118 exceeds the threshold 120, the computer system may make the adjustment 116 in block 512. By committing the adjustment 116 to the logic network 102, the computer system may improve a given metric of the logic network 102 without changing the logical functionality of the logic network 102.

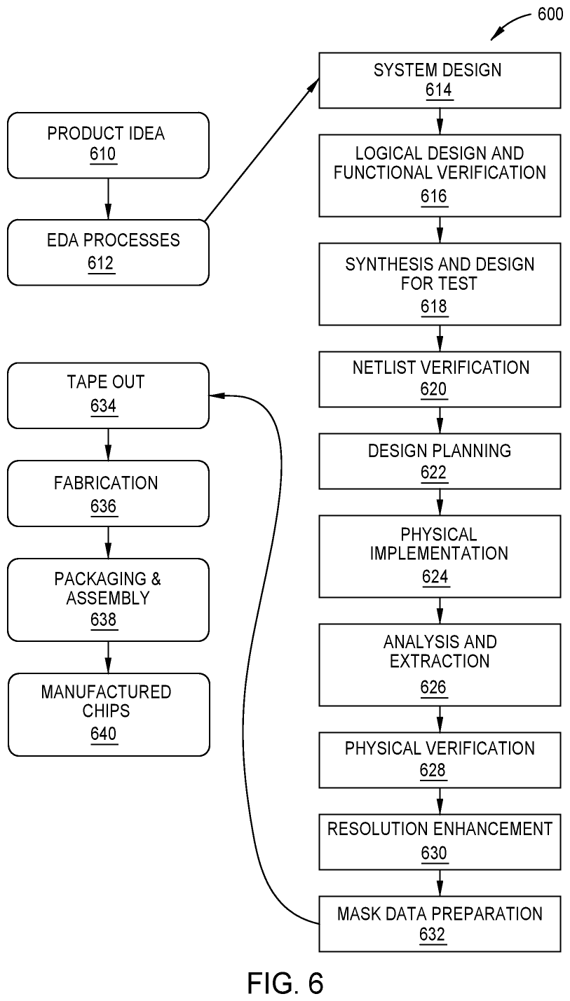

FIG. 6 illustrates an example set of processes 600 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 610 with information supplied by a designer, information which is transformed to create an article of manufacture that uses a set of EDA processes 612. When the design is finalized, the design is taped-out 634, which is when artwork (e.g., geometric patterns) for the integrated circuit is sent to a fabrication facility to manufacture the mask set, which is then used to manufacture the integrated circuit. After tape-out, a semiconductor die is fabricated 636 and packaging and assembly processes 638 are performed to produce the finished integrated circuit 640.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 6. The processes described by be enabled by EDA products (or EDA systems).

During system design 614, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 616, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 618, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 620, the netlist is checked for compliance with timing constraints and for correspondence with the HDL code. During design planning 622, an overall floor plan for the integrated circuit is constructed and analyzed for timing and top-level routing.

During layout or physical implementation 624, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 626, the circuit function is verified at the layout level, which permits refinement of the layout design. During physical verification 628, the layout design is checked to ensure that manufacturing constraints are correct, such as DRC constraints, electrical constraints, lithographic constraints, and that circuitry function matches the HDL design specification. During resolution enhancement 630, the geometry of the layout is transformed to improve how the circuit design is manufactured.

During tape-out, data is created to be used (after lithographic enhancements are applied if appropriate) for production of lithography masks. During mask data preparation 632, the ‘tape-out’ data is used to produce lithography masks that are used to produce finished integrated circuits.

A storage subsystem of a computer system (such as computer system 700 of FIG. 7) may be used to store the programs and data structures that are used by some or all of the EDA products described herein, and products used for development of cells for the library and for physical and logical design that use the library.

FIG. 7 illustrates an example machine of a computer system 700 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM), a static memory 706 (e.g., flash memory, static random access memory (SRAM), etc.), and a data storage device 718, which communicate with each other via a bus 730.

Processing device 702 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 may be configured to execute instructions 726 for performing the operations and steps described herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a non-transitory computer-readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In some implementations, the instructions 726 include instructions to implement functionality corresponding to the present disclosure. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 702 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method for adjusting a logic network, the method comprising:
adding, to the logic network, a first redundant node;
determining a first adjustment to a first node of the logic network within a transitive fanin of the first redundant node; and
making the first adjustment to the first node based on determining that a first gain based on the first adjustment satisfies a threshold.

2. The method of claim 1, further comprising:
adding, to the logic network, a second redundant node;
determining a second adjustment to a second node of the logic network within a transitive fanin of the second redundant node; and
removing the second redundant node from the logic network based on determining that the threshold exceeds a second gain based on the second adjustment.

3. The method of claim 1, wherein the first redundant node is determined based one or more of a truth table or a binary decision diagram of the logic network.

4. The method of claim 1, wherein the first adjustment comprises removal of the first node.

5. The method of claim 1, wherein the first adjustment comprises substituting the first node with another node in the logic network.

6. The method of claim 1, wherein adding the first redundant node to the logic network maintains functionality of an output of the logic network.

7. The method of claim 1, further comprising:
selecting a second node of the logic network; and
forming, from the second node, a window encompassing the second node and a third node of the logic network, wherein the second node and the third node are in the transitive fanin of the first redundant node, and wherein the first redundant node is added based on the window.

8. The method of claim 7, wherein the third node is outside a transitive fanout of the second node.

9. The method of claim 1, wherein the first redundant node comprises one or more of an AND gate or an OR gate.

10. The method of claim 1, wherein the first gain comprises one or more of an area of the logic network, a power consumption of the logic network, or a number of gates in the logic network.

11. A system for adjusting a logic network, the system comprising:
a memory; and
a processor communicatively coupled to the memory, the processor configured to:
add, to the logic network, a first redundant node;
determine a first adjustment to a first node of the logic network within a transitive fanin of the first redundant node; and
make the first adjustment to the first node based on determining that a first gain based on the first adjustment satisfies a threshold.

12. The system of claim 11, wherein the processor is further configured to:
add, to the logic network, a second redundant node;
determine a second adjustment to a second node of the logic network within a transitive fanin of the second redundant node; and
remove the second redundant node from the logic network based on determining that the threshold exceeds a second gain based on the second adjustment.

13. The system of claim 11, wherein the first redundant node is determined based on a truth table of the logic network.

14. The system of claim 11, wherein the first adjustment comprises removal of the first node.

15. The system of claim 11, wherein the first adjustment comprises substituting the first node with another node in the logic network.

16. The system of claim 11, wherein adding the first redundant node to the logic network maintains functionality of an output of the logic network.

17. The system of claim 11, wherein the processor is further configured to:
select a second node of the logic network; and
form, from the second node, a window encompassing the second node and a third node of the logic network, wherein the second node and the third node are in the transitive fanin of the first redundant node, and wherein the first redundant node is added based on the window.

18. The system of claim 11, wherein the first redundant node comprises one or more of an AND gate or an OR gate.

19. A non-transitory computer readable medium storing instructions that, when executed by a processor, cause the processor to:
form, from a first node of a logic network, a window encompassing the first node and a second node of the logic network, wherein the second node is in a transitive fanin of the first node;
add at least one of an AND gate or an OR gate to the logic network such that an output of the first node and an output of the second node are input to the AND gate or OR gate;
based on a truth table of the logic network remaining unchanged after adding the AND gate or OR gate, determine an adjustment to a third node of the logic network within the transitive fanin of the first node; and
make the adjustment to the third node based on determining that a gain based on the adjustment satisfies a threshold.

20. The medium of claim 19, wherein the adjustment comprises at least one of (i) removing the third node from the logic network or (ii) substituting the third node with another node in the logic network.
